(19) United States
(12) Patent Application Publication
(10) Pub. No.: US 2006/0182304 A1
(43) Pub. Date: Aug. 17, 2006

(54) Speaker, module employing it, electronic apparatus and device

(76) Inventors: Tomoyasu Takase, Mie (JP); Masanori Nakano, Mie (JP); Masahide Sumiyama, Mie (JP)

Correspondence Address: WENDEROTH, LIND & PONACK, L.L.P., 2033 K STREET N. W., SUITE 800, WASHINGTON, DC, 20006-1021, US

(21) Appl. No.: 10/546,734

(22) PCT Filed: Feb. 18, 2005
(86) PCT No.: PCT/JP05/02581

§ 371 Date: Aug. 24, 2005

(30) Foreign Application Priority Data
Mar. 11, 2004 (JP) 2004-068572

(51) Int. Cl. H04R 9/06

(52) U.S. Cl. 381/412; 381/423

(57) ABSTRACT

Shield cover (29) made of a magnetic material covers yoke (23) in internal magnetic circuit (24) of a speaker so as to reduce magnetic leakage from internal magnetic circuit (24).

### TECHNICAL FIELD

The present invention relates to speakers, and more particularly to speakers that show reduced magnetic leakage.

### BACKGROUND ART

FIG. 7 is a sectional view of a conventional speaker disclosed in the Unexamined Japanese Utility Model Publication No. S61-33590 that reduces magnetic leakage. Internal magnetic circuit 4 is configured by sandwiching permanent magnet 1 between top plate 2 and yoke 3. Voice coil 8, attached to diaphragm 7, is inserted into magnetic gap 5 of magnetic circuit 4. Since magnetic circuit 4 has an internal magnet structure, magnetic leakage from the permanent magnet is small.

Accordingly, this speaker has less detrimental effect on magnetic cards such as credit cards in the user's pocket or bag even if the speaker is placed near them. The speaker is thus fit to use for mobile phones. In response to various market demands for mobile phones, however, the magnetic energy of their speakers' permanent magnets is showing a steady increase. Consequently, magnetic leakage from permanent magnets is becoming greater, causing the risk of detrimental effects on magnetic cards.

### SUMMARY OF THE INVENTION

A speaker of the present invention includes an internal magnetic circuit configured by sandwiching a permanent magnet between a top plate and yoke; a frame attached to the internal magnetic circuit; a diaphragm attached to a circumference of the frame; a voice coil attached to the diaphragm; and a shield cover covering the entire exposed area of the yoke at the rear side. The shield cover reduces magnetic leakage from the permanent magnet.

### BRIEF DESCRIPTION OF THE DRAWINGS

FIG. 1 is a sectional view of a speaker in accordance with the first exemplary embodiment of the present invention.

FIG. 2 is a sectional view of a speaker in accordance with the second exemplary embodiment of the present invention.

FIG. 3 is a sectional view of a speaker in accordance with the third exemplary embodiment of the present invention.

FIG. 4 is a sectional view of a speaker module in accordance with the fourth exemplary embodiment of the present invention.

FIG. 5 is a sectional view of a key part of an electronic apparatus in accordance with the fifth exemplary embodiment of the present invention.

FIG. 6 is a sectional view of equipment in accordance with the sixth exemplary embodiment of the present invention.

FIG. 7 is a sectional view of a conventional speaker.

### REFERENCE MARKS IN THE DRAWINGS

21 Permanent magnet
22 Top plate
23 Yoke
24 Magnetic circuit
25 Magnetic gap
26 Frame
27 Diaphragm
28 Voice coil
29 Shield cover
30 Double-sided adhesive tape
31 Speaker
40 Electronic circuit
41 Circuit board
42 Electronic component
50 Speaker module
60 Display module
70 Casing
80 Mobile phone
90 Vehicle

### BEST MODE FOR CARRYING OUT THE INVENTION

Exemplary embodiments of the present invention are described below with reference to drawings.

### First Exemplary Embodiment

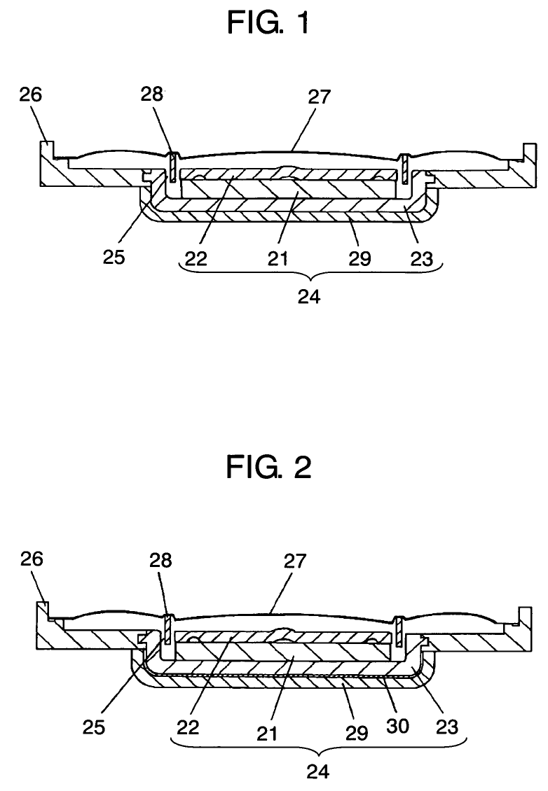

FIG. 1 is a sectional view of a speaker in the first exemplary embodiment of the present invention. Top plate 22 and yoke 23 made of a material with high magnetic permeability, such as Permendur, sandwich magnet 21 to configure internal magnetic circuit 24.

Resin frame 26 is attached to yoke 23. The circumference of diaphragm 27 is bonded onto the rim of frame 26, and voice coil 28 attached to diaphragm 27 is inserted into magnetic gap 25 of magnetic circuit 24. Shield cover 29 made of a silicon steel plate covers the entire exposed area of yoke 23 at its rear side, and is attached to yoke 23. This structure significantly reduces magnetic leakage from internal magnetic circuit 24.

Since frame 26 is made of resin, a nonmagnetic material, no magnetic flux leaks from frame 26. In addition, yoke 23 made of Permendur, a material with high magnetic permeability, increases saturated magnetic flux density, and thus reduces magnetic leakage to the outside. Still more, shield cover 29, made of a silicon steel plate, improves the blocking of leaking magnetic flux by shield cover 29, and thus reduces magnetic leakage to the outside. Accordingly, the speaker of the present invention, and electronic apparatuses such as mobile phones employing this speaker, can show reduced detrimental effects of magnetic leakage on other apparatuses.

### Second Exemplary Embodiment

FIG. 2 is a sectional view of a speaker in the second exemplary embodiment of the present invention. The same components as in the first exemplary embodiment are given the same reference marks and their details are omitted. As shown in FIG. 2, yoke 23 and shield cover 29 are attached with nonmagnetic double-sided adhesive tape 30 provided in between. Generally speaking, yoke 23 and shield cover 29 are coupled via nonmagnetic clearance 30 in between. Accordingly, magnetic leakage can be further reduced by the provision of a nonmagnetic clearance in between so as to achieve a non-continuous structure instead of a continuous structure for yoke 23 and shield cover 29.

### Third Exemplary Embodiment

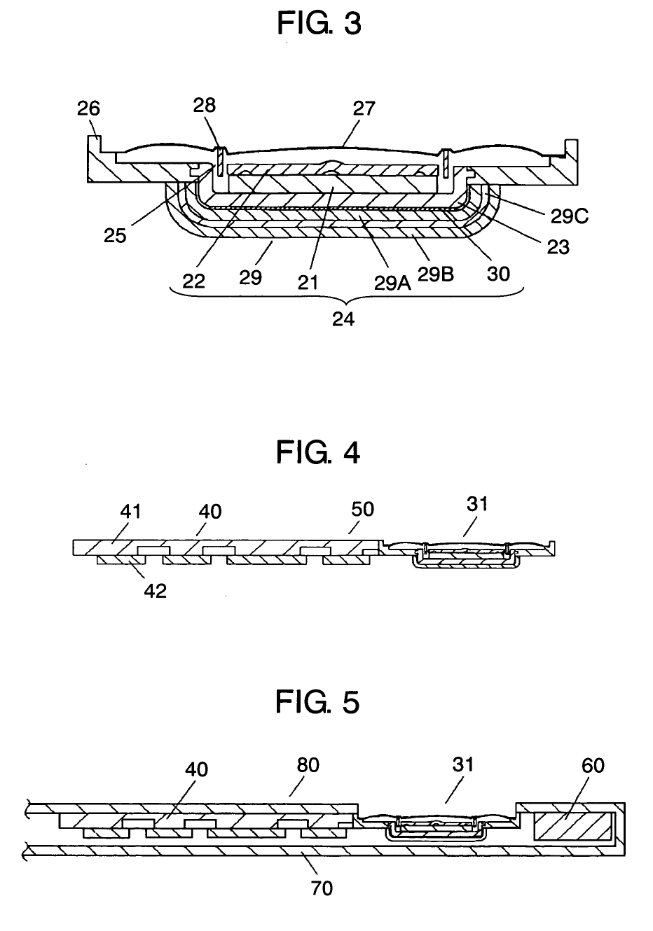

FIG. 3 is a sectional view of a speaker in the third exemplary embodiment of the present invention. The same components as in the first exemplary embodiment are given the same reference marks and their details are omitted. As shown in FIG. 3, shield cover 29 has a multi-layer structure made of two or more magnetic metal sheets 29A and 29B which are insulated by providing insulating layer 29C between the metal sheets. This multi-layer structure improves the blocking of leaking magnetic flux by shield cover 29, and thus reduces magnetic leakage.

### Fourth Exemplary Embodiment

FIG. 4 is a sectional view of a speaker module in the fourth exemplary embodiment of the present invention. As shown in FIG. 4, speaker 31 of the present invention and electronic circuit 40 are integrated to configure speaker module 50. Electronic circuit 40 is configured by mounting electronic component 42 on circuit board 41. This electronic circuit 40 includes an amplifying circuit for audio signals.

Accordingly, the sound is output by connecting an audio signal source to this speaker module 50. Electronic circuit 40 can also include, if required, circuits needed for communications such as a detection circuit, a modulation circuit, and a demodulation circuit; a driving circuit for display means such as liquid crystal; a power circuit; and a charging circuit. The use of speaker module 50, as described above, which integrates speaker 31 and electronic circuit 40, is effective for diverse purposes.

### Fifth Exemplary Embodiment

FIG. 5 is a sectional view of a mobile phone in the fifth exemplary embodiment of the present invention. As shown in FIG. 5, speaker 31 of the present invention is installed in mobile phone 80. Mobile phone 80 includes speaker 31, electronic circuit 40, and display module 60 such as liquid crystal disposed inside casing 70. Since speaker 31 of the present invention reduces magnetic leakage, this configuration achieves a mobile phone with less magnetic leakage.

### Sixth Exemplary Embodiment

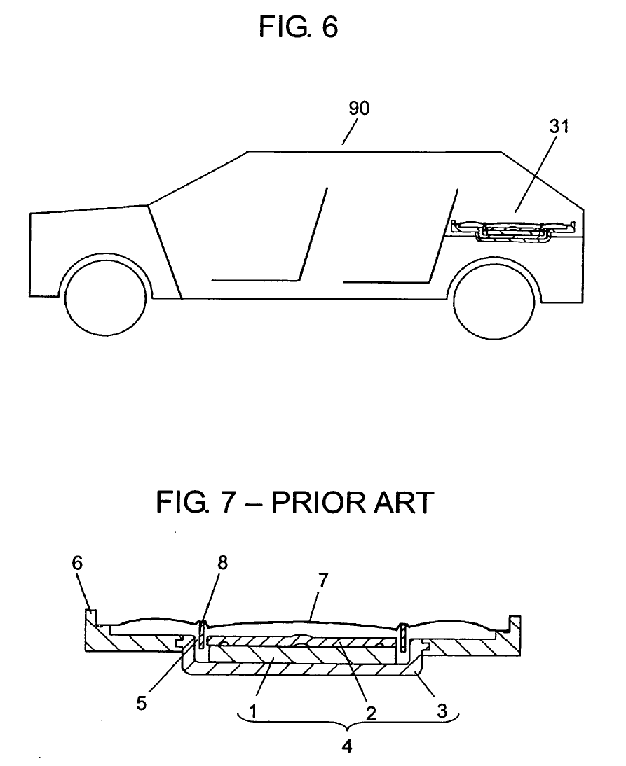

FIG. 6 shows the sixth exemplary embodiment of the present invention. As shown in FIG. 6, apparatuses such as car navigation systems and car audio equipment that show reduced magnetic leakage by employing speaker 31 of the present invention are installed in vehicle 90.

### INDUSTRIAL APPLICABILITY

The speaker of the present invention is broadly applicable to apparatuses that need to show reduced magnetic leakage.

1. A speaker comprising:
an internal magnetic circuit configured by sandwiching a permanent magnet between a top plate and a yoke;
a frame attached to the internal magnetic circuit;
a diaphragm attached to a circumference of the frame;
a voice coil attached to the diaphragm; and
a shield cover that covers an entire exposed area of the yoke at its rear side.

2. The speaker as defined in claim 1, wherein the shield cover covers the yoke via a nonmagnetic clearance.

3. The speaker as defined in claim 1, wherein the shield cover covers the yoke via a double-sided adhesive tape.

4. The speaker as defined in claim 1, wherein the frame is made of resin.

5. The speaker as defined in claim 1, wherein the yoke is made of a material with high magnetic permeability.

6. The speaker as defined in claim 5, wherein Permedur is used as the material with high magnetic permeability.

7. The speaker as defined in claim 1, wherein the shield cover is made of a silicon steel plate.

8. The speaker as defined in claim 1, wherein the shield cover has a multi-layer structure made of at least two magnetic metal sheets insulated from each other.

9. A module integrating the speaker of claim 1 and an electronic circuit.

10. An electronic apparatus installing the speaker of claim 1.

11. Equipment installing the speaker of claim 1.
